(19) United States
(12) Patent Application Publication
(10) Pub. No.: US 2007/0198332 A1
(43) Pub. Date: Aug. 23, 2007

(54) Plurality of Stackable Dishware

(76) Inventor: Iduol Beny, Westminster, CA (US)

Correspondence Address: APEX PATENTS, LLC, PMB 1477, 1122 EAST PIKE STREET, SEATTLE, WA, 98122, US

(21) Appl. No.: 11/307,727

(22) Filed: Feb. 18, 2006

(51) Int. Cl. G07C 13/00

(52) U.S. Cl. 705/12

(57) ABSTRACT

A plurality of stackable dishware, the stackable dishware comprising a first dishware and a second dishware, the second dishware configured to being stackable adjacent to the first dishware, wherein the first and second dishware are configured to defining a three dimensional shape when stacked.

### FIELD OF INVENTION

The present invention relates to dishware; more specifically, it relates to systems and methods for providing stackable dishware.

### BACKGROUND OF THE INVENTION

Many cultures use dishware such as bowls, plates, cups, ashtrays, and coasters, while also using various instruments such as knives, forks and spoons to aid in cutting, arranging, and consuming food. The dishware is typically sold in sets having limited matching designs, sizes, and shapes. For instance, a set may have a number of small plates, a number of large plates, a single size of bowls, and a single size of glasses. Even dishware sold separately is often standardized so as to conform to other typical dishware. These dishware sets, as well as individually sold dishware, present a number of problems.

First, dishware sizes within a set often do not address the various consumption needs for a given user. For example, the user might wish to serve a quantity or size of food that is too large to be reasonably served on a smaller plate, yet too small to be reasonably served on a larger plate. Accordingly, several unfortunate situations may result.

First, the user may choose to use the smaller plate and reduce the quantity or size of food that the user serves in order to fit the capacity of the smaller plate. This situation may result in the appetite of the user not being satisfied. Second, the user may choose to use the larger plate and either increase the amount of food the user serves or choose to keep the quantity or size of food the same. If kept the same, the presentation of the food may not be ideal or esthetically pleasing. If the quantity or size of food is increased, it may lead to overeating or waste of food that is not eaten because of an inappropriate food proportion in relation to the appetite of the user. Finally, the user may choose to not consume or serve the food at all, which would also result in an unsatisfied appetite.

Therefore, the standardized size of dishware, either in sets or sold independently, presently leads to instances where a user experiences an inadequate satiation of appetite or an eating experience that is not esthetically pleasing.

Next, it is difficult to efficiently and securely store dishware. This problem is present with dishware sets and is even more pronounced with individual non-standardized pieces. Typically, similarly sized dishware is stacked with the base of one dishware resting on the top of the dish are below it. Other common sized dishware is stacked similarly in proximate positions. Non-standard sized dishware is often stored independently. First, this storage methodology takes up space and is inefficient. Second, this configuration is not secure, and the plates can easily shift and slide resulting in damage.

Furthermore, the traditional storage method of dishware, either stacked or placed alone, leaves the consumption surface of the dishware in contact with the open air, which creates issues of hygiene and cleanliness. As a result of the contact with the open air, dust, debris, airborne bacteria and viruses can freely contact the dishware. The longer the dishware is stored, the greater the likelihood that users of the dishware will be exposed to undesirable particles or pathogens.

In short, traditional dishware suffers from being limited to standardized sizes, inefficient to store, easily damaged when stored, and open to particles and pathogens. This invention solves these and many other problems.

### SUMMARY

The present invention relates to dishware; more specifically, it relates to systems and methods for providing stackable dishware. In one embodiment, the invention includes a plurality of stackable dishware, the stackable dishware comprising a first dishware and a second dishware, the second dishware configured to being stackable adjacent to the first dishware, wherein the first and second dishware are configured to define a three dimensional shape when stacked.

### BRIEF DESCRIPTION OF THE DRAWINGS

Preferred and alternate embodiments of the present invention are described in detail below with reference to the following drawings:

FIG. 1 is a top view of a plurality of stackable dishware, in accordance with an embodiment of the invention;

FIG. 2 is a perspective view of the plurality of stackable dishware, in accordance with an embodiment of the invention;

FIG. 3 is an exploded view of the plurality of stackable dishware, in accordance with an embodiment of the invention;

FIG. 4 is a side view of the plurality of stackable dishware, in accordance with an embodiment of the invention;

FIG. 5 is a cross section of the plurality of stackable dishware, in accordance with an embodiment of the invention;

FIG. 6 is a close-up cross section of the perimeter a single internal dishware, in accordance with an embodiment of the invention; and

FIG. 7 is a close-up cross section of the perimeter of two stacked internal dishware, in accordance with an embodiment of the invention.

### DETAILED DESCRIPTION

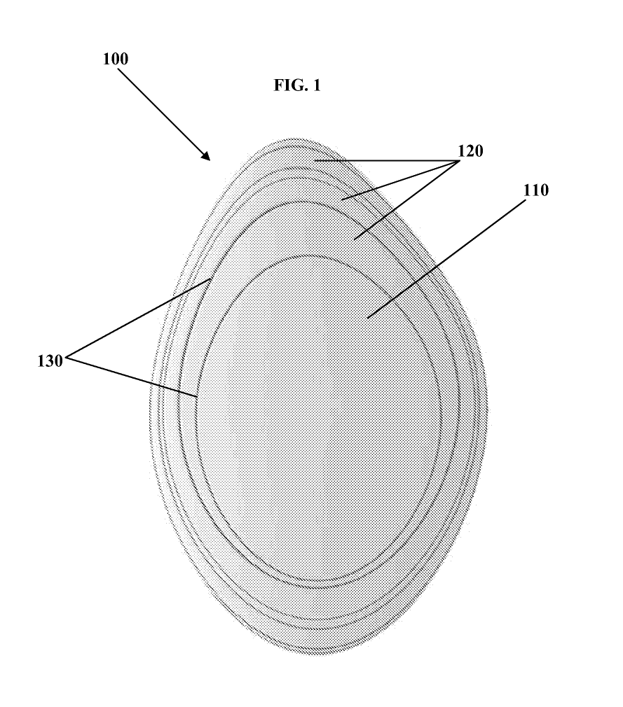

The present invention relates to dishware; more specifically, it relates to systems and methods for providing stackable dishware. Specific details of certain embodiments of the invention are set forth in the following description and in FIGS. 1-7 to provide a thorough understanding of such embodiments. The present invention may have additional embodiments, or may be practiced without one or more of the details described for any particular described embodiment.

FIG. 1 is a top view of a plurality of stackable dishware 100, in accordance with an embodiment of the invention. The stackable tableware 100 includes a top cap dishware 110, a plurality of internal dishware 120, and a seam 130.

In one embodiment, the cap dishware 110 is placed adjacent to the internal dishware 120 and the internal dishware 120 is placed adjacent to other internal dishware 120 and a bottom cap dishware (not shown). The placement of the dishware results in the seam 130 that is shown in the illustration. Any of the cap dishware 110, the internal dishware 120, or the bottom cap dishware may be removed by simply lifting the adjacent dishware.

In another embodiment, any of the dishware may include a plate, a bowl, an ashtray, a cup, a coaster or any other dishware. In yet another embodiment, the stackable dishware may define any shape including a cube, rectangular cube, sphere, or other non-uniform shape.

In a still further embodiment, there may be no internal dishware, and the plurality of stackable dishware comprises a bottom cap dishware and a top cap dishware.

In a yet further embodiment, there may be any number of internal dishware and single pieces of internal dishware may be removed such that the three dimensional shape that results from stacking does not lose its continuity.

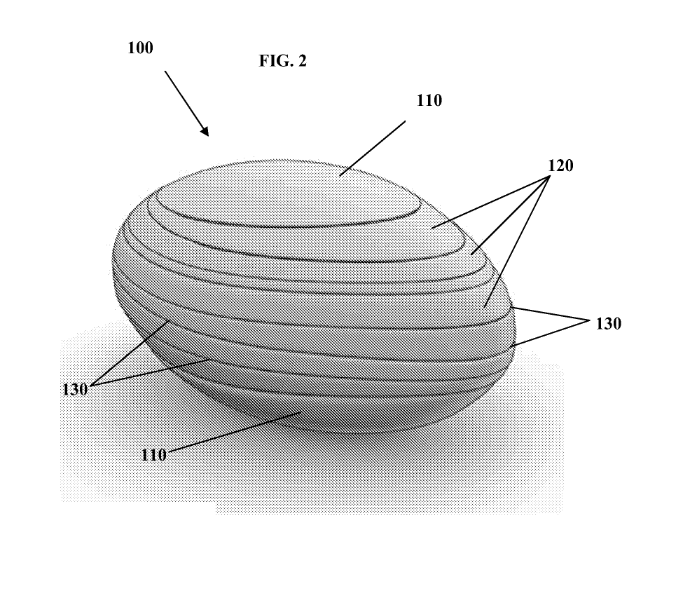

FIG. 2 is a perspective view of the plurality of stackable dishware 100, in accordance with an embodiment of the invention. The stackable dishware includes the cap dishware 110, a plurality of internal dishware 120, and a seam 130, which is a result of the dishware being adjacent to each other.

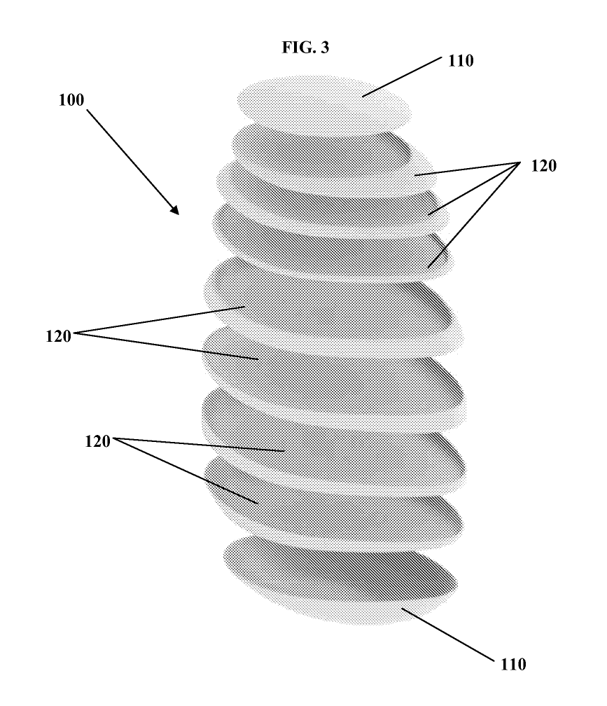

FIG. 3 is an exploded view of the plurality of stackable dishware 100, in accordance with an embodiment of the invention. FIG. 3 depicts the cap dishware 110 and a plurality of internal dishware 120. The internal dishware 120 includes various sizes of plates. Each plate includes an outer ridge that serves as a barrier for food during consumption and/or a structural support while stacked adjacent to other dishware. In certain embodiments, any of the dishware includes bowls, plates, coasters, cups and other dishware. In one particular embodiment, the plurality of stackable dishware 100 further includes areas for utensils, measuring tools, knives, or other cooking, bar-tending, or serving device, either internally or externally.

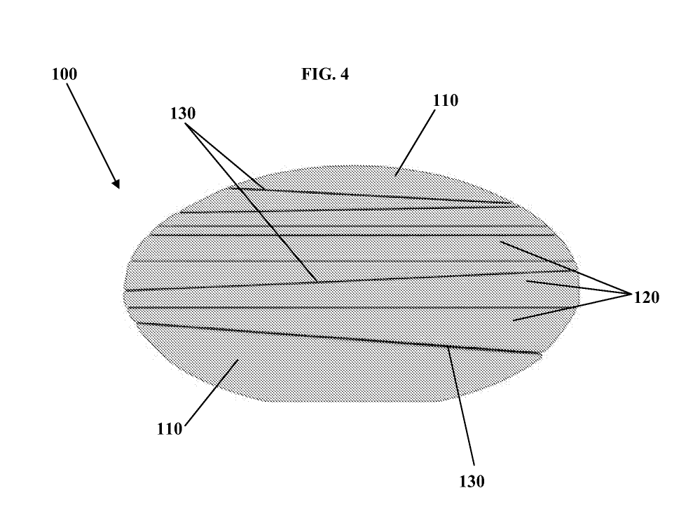

FIG. 4 is a side view of the plurality of stackable dishware 100, in accordance with an embodiment of the invention. The stackable dishware includes the cap units 110, a plurality of internal units 120, and a seam 130, which results from the dishware being stacked. In this embodiment, the seam 130 that results from the dishware being stacked is at various angles to the ground including parallel and non-parallel angles.

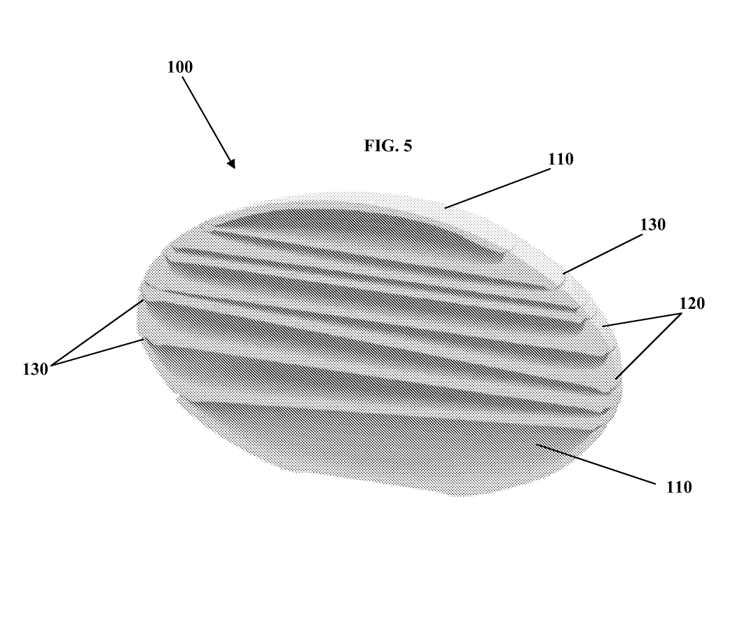

FIG. 5 is a cross section of the plurality of stackable dishware 100, in accordance with an embodiment of the invention. FIG. 5 similarly depicts the cap dishware 110, a plurality of internal dishware 120, and a seam 130, which results from the dishware being stacked.

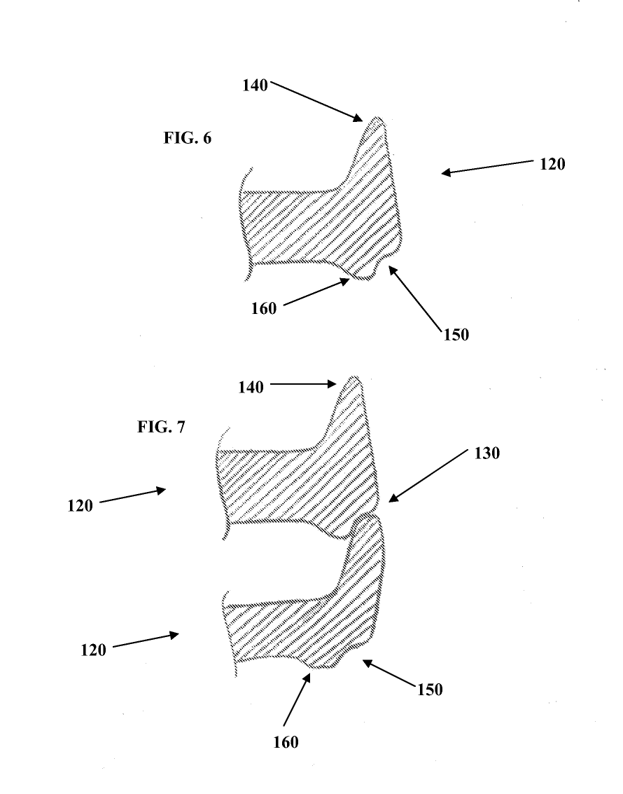

FIG. 6 is a close-up cross section of the outer rim of one internal dishware 120, in accordance with an embodiment of the invention. In one embodiment, the outer rim of the one internal dishware 120 comprises a lip 140, a depression 150, and a base 160. The base 160 creates a limited surface on the bottom perimeter of the internal dishware suitable for contacting a surface that the internal dishware may be placed upon.

In further embodiments the base may be any shape, such as a triangle or square, oval or hexagon. In a yet further embodiment, the base is not contiguous along the full perimeter of the internal dishware and comprises of a plurality of protrusions that may be in any shape, such as a point, hemisphere, cube or rectangle and in any configuration on the bottom of the internal dishware. In a still further embodiment the base is absent.

FIG. 7 is a close-up cross section of the outer edge of two internal dishware 120, in accordance with an embodiment of the invention. In one embodiment, the seam 130 is defined by the junction of a lip 140 on one of the plurality of a first internal dishware 120 joining a depression 150 in a second adjoining internal dishware 120.

In one particular embodiment, the seam 130 is air tight. In certain embodiments, the air tightness is achieved using a rubber or foam liner along the lip of the edge of the dishware or within the depression or both. In another embodiment, the dishware is snapped together using internal or external fasteners (not shown). In yet a further embodiment, the dishware is leaned together rather than stacked, such as to form a pyramid or other shape. In this embodiment, a frame may be added for support as necessary.

In another embodiment the seam 130 is created by any configuration of lip and matching depression or any other suitable method of coupling adjoining dishware. Suitable means of coupling adjoining dishware include, but are not limited to, slots, pins, grooves, indentations, notches, and complementary shaping.

In another embodiment, the plurality of stackable dishware 100 includes plates. In a still further embodiment, the plurality of stackable dishware 100 includes bowls. In an even further embodiment, the plurality of stackable dishware 100 includes plates and bowls.

In a further embodiment, the plurality of stackable dishware 100 includes one or more of any type of dishware including, but not limited to, cups, bowls, plates, saucers, dishes, platters, trays, mugs and boats. The any type of dishware may be any of the plurality of internal dishware 120 or the cap dishware 110.

In a still further embodiment, the plurality of stackable dishware 100 may be made from one or more or a combination, mixture, or composite of glass, wood, paper, plastic, ceramic, stone, metal, porcelain, resin, or other material. In yet further alternative embodiments, one or more of the plurality of internal dishware 120 or the cap dishware 110 may include a texture, pattern, or image of any shape, color or size, either regular or irregular.

In a further embodiment, the plurality of stackable dishware 100 may resemble a regular three dimensional shape including but not limited to a sphere, oblong sphere, cube, cylinder, pyramid, tetrahedron, cones, or various types of prisms. In other embodiments, the plurality of stackable tableware may resemble irregular or amorphous three dimensional shapes or may be shaped to depict any person, place or thing, either real or fictitious.

In yet another embodiment, the plurality of stackable dishware 100 is designed such that one or more of the plurality of internal dishware 120 and the cap dishware 110 are stackable in a fashion wherein the edge of any individual dishware is perpendicular, parallel, or any other angle in relation to the ground. Moreover, the angles of relation to the ground need not be the same for any or all of the plurality of internal dishware 120 or the cap dishware 110.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined by reference to the claims that follow.

What is claimed is:

1. A plurality of stackable dishware, the stackable dishware comprising:
a first dishware; and
a second dishware, the second dishware configured to being stackable adjacent to the first dishware, wherein the first and second dishware are configured to defining a three dimensional shape when stacked.

2. The plurality of stackable dishware of claim 1, wherein any of the first and second dishware are any of plates, bowls, coasters, platters, and cups.

3. The plurality of stackable dishware of claim 1, wherein the three dimensional shape is any of a sphere, oval, rectangle, and box.

4. The plurality of stackable dishware of claim 1, wherein at least one of the first and second dishware includes a base.

5. The plurality of stackable dishware of claim 1, wherein any of the first and second dishware include a lip and a depression.

6. The plurality of stackable dishware of claim 1, wherein the first and second dishware are of different sizes.

7. A method of stacking dishware, the method comprising the steps of: providing a first dishware;
providing a second dishware;
stacking the second dishware on the first dishware,
wherein the first and the second dishware are of different sizes, and wherein the first and the second dishware form at least a part of a three dimensional shape when stacked.

8. The method of stacking dishware in claim 6, further comprising:
providing a third dishware; stacking the third dishware on the second dishware, wherein the first dishware, the second dishware, and the third dishware are configured to form at least part of a three dimensional shape when stacked.

9. The method for stacking dishware in claim 7 further comprising:
providing a fourth dishware;
stacking the third dishware on the third dishware,
wherein the first dishware, second dishware, third dishware, and fourth dishware are configured to form at least part of a three dimensional shape when stacked.
